(19) United States
(12) Patent Application Publication
(10) Pub. No.: US 2012/0266145 A1
(43) Pub. Date: Oct. 18, 2012

(54) APPARATUS AND METHOD FOR AUTOMATICALLY ANALYZING THE USAGE OF AN APPLICATION'S USER INTERFACE

(76) Inventors: Arnaud Gonguet, Nozay (FR); Yann Gaste, Nozay (FR)

(21) Appl. No.: 13/503,919

(22) PCT Filed: Oct. 15, 2010
(86) PCT No.: PCT/EP10/65522

§ 371 Date: Jul. 3, 2012

(30) Foreign Application Priority Data
Oct. 29, 2009 (FR) 0957632

(51) Int. Cl. G06F 11/36

(52) U.S. Cl. 717/131

(57) ABSTRACT

An apparatus (D) is dedicated to analyzing the use by at least one user of at least one user interface (IG) associated with an application (AP). This apparatus (D) comprises analysis means (MA) operative to compare first data representative of first actions performed by the user by means of that user interface (IG) in order to carry out tasks required by the associated application (AP), with second data, representative of second actions that that user should have performed by means of that user interface (IG) in order to carry out those required tasks, and third data, representative of the way in which that user should have performed those second actions, in order to determine any differences representative of shortcomings of that user interface (IG).

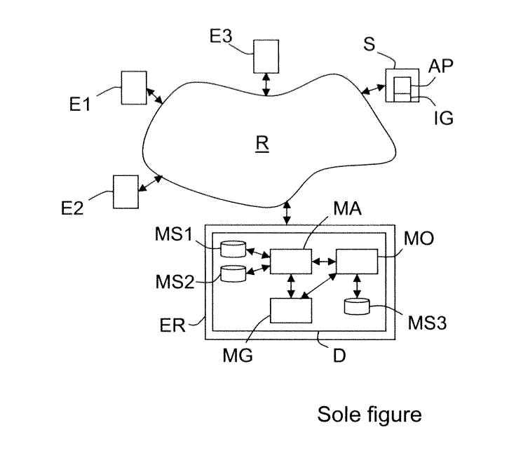

The invention pertains to applications that are used in a distributed or centralized fashion by one or more users via a device (potentially a communication device), and more specifically the user interfaces that enable users to use these applications.

Here, the term “user interface” refers to all software elements that constitute a graphical user interface that is displayed on the screen (or monitor) of a user device, potentially a communicating device, and with which that user may interact via one or more peripherals, such as a keyboard, mouse, or touchscreen, to perform actions needed to carry out an application's tasks, and/or all hardware and software elements that constitute an audio interface enabling a user to provide (or dictate) keywords intended to trigger actions needed to carry out an application's tasks.

Furthermore, the term “user device” refers here to any type of electronic hardware that has a screen or monitor and is capable of using at least one application that it hosts or which it may access via a wired or wireless communication network. Consequently, it may, for example, be a desktop or portable computer, a fixed-line or mobile telephone, a personal digital assistant (or PDA), potentially a communicating one, a game console that may potentially be a communicating one, a home appliance that may potentially be a communicating one, a television set that may potentially be a communicating one, or a multimedia content receiver (such as an STB or “Set-Top Box”).

The (graphical) user interfaces associated with applications are generally designed by software engineers who can very quickly and easily manage the fields and menus displayed on their electronic device screens (or monitors), and which make it possible to dialogue with applications. As a result, some of the user interfaces that they design may partially be ill-suited for people who are unfamiliar with graphical user interfaces, despite heuristics having been taken into account

It is therefore important for the designers of user interfaces to tell whether or not these interfaces are suitable for the users of the associated applications, so as to be able to adapt (or modify) them if need be.

At least two solutions have been proposed in order to obtain from application users information regarding the associated user interfaces.

A first solution consists of asking a panel (or representative group) of people to carry out a predefined set of tasks in a controlled environment using an application's user interface, to record the people's reactions, and to collect their opinions. It should be understood that such a solution takes a great deal of time, particularly in selecting the people who are to carry out a test and to organize the panels, then to analyze the recorded reactions and the collected opinions. Additionally, it requires having experts to conduct the analyses and then determine changes to be made to the tested user interface.

A second solution consists of automatically collecting the opinions from the users of user interfaces by means of a dedicated service (for example an Internet (or web) service). The primary drawback of this method resides in the fact that the collected information generally comes in the form of vague criticisms that result from problems or faults encountered (or “bug reporting”), which is therefore difficult to use, even for experts, in order to optimize a user interface. Furthermore, it is well known among sociologists that the users generally do not say what they actually think, but what they think they are supposed to say, to the point that the collected opinions do not accurately reflect their experience.

The purpose of the invention is therefore to improve the situation.

To that end, it proposes an apparatus intended to automatically analyze the use by at least one user of at least one user interface associated with an application, and comprising analysis means operative to compare first data, representative of first actions carried out by that user using that user interface in order to perform tasks required by the associated application, with second data, representative of second actions that that user should have performed by means of that user interface to perform those required tasks, and third data representative of the way in which that user should have performed those second actions, in order to determine any differences representative of shortcomings of that user interface.

The inventive device may comprise other characteristics, which may be taken separately or in combination, in particular:
its analysis means may be operative to use first data that is representative of events generated by the user interface and/or by the associated application whenever a user carries out first actions with that user interface;
its analysis means may be operative to use second data that is representative of functional definitions of second actions that make it possible to perform tasks, and third data that is representative of usage models of the second actions for successfully performing those tasks;
it may comprise a first storage means operative to store the second data;
it may comprise a first storage means operative to store the third data;
its analysis means may be operative to measure the time taken by a user to perform a second action or a task requiring at least one second action and to use that measured time as first data;
it may comprise optimization means operative, whenever its analysis means have determined at least one difference, to determine whether the user interface in question can be modified in order to keep each difference from reappearing again, and if so, to determine at least one modification to that user interface intended to enable each user in question to more easily perform the tasks required by the application in question;
   the optimization means may be operative to modify the user interface in question as a function of variants in the presentation of tasks to be performed, which constitute alternatives to task presentations used up to that point;
      it may comprise a third storage means operative to store the alternative presentation variants;
   it may comprise generation means operative to store each modification determined by the optimization means and to generate a report whenever the analysis means can no longer determine any significant differences subsequent to modifications made to the user interface in question;
its analysis means and/or optimization means may be arranged in the form of a rule engine.

The invention also proposes an information processing program (or computer program) intended to be used by an electronic device, and constituting an analysis apparatus of the type presented above.

The invention also proposes a network device, intended to be connected to a communication network that offers access to at least one application, and comprising an analysis apparatus of the type presented above.

The invention also proposes a user device comprising at least one application and analysis apparatus of the type presented above.

The invention also proposes a method intended to automatically analyze the use by at least one user of at least one user interface associated with an application, and comprising a step consisting of comparing first data representative of first actions performed by that user by means of that user interface in order to carry out tasks required by the associated application, with second data representative of second actions that that user should have performed by means of that user interface in order to carry out those required tasks, and third data representative of the way in which that user should have performed those second actions, in order to determine any differences representative of shortcomings of that user interface.

Furthermore, this method may also comprise a step consisting, in the event that at least one difference is determined, of determining whether the user interface can be modified to prevent each difference from reappearing again, and if so, to determine at least one modification to that user interface intended to enable each user in question to more easily perform the tasks required by the application in question.

Other characteristics and advantages of the invention will become apparent upon examining the detailed description below, and the attached drawing, in which the sole FIGURE schematically depicts a communication network, to which three user communication devices, an application server, and a network device equipped with an example embodiment of an analysis apparatus according to the invention are all connected.

The drawing may serve not only to complete the invention, but also to contribute to defining it, if need be.

It is an object of the invention to enable the automatic analysis of the usage by at least one electronic device user Ei of at least one user interface IG associated with an application AP.

In what follows, it is assumed by way of a nonlimiting example that the users are equipped with wired communication devices Ei, such as computers, which may connect to a wired communication network R (such as an ADSL network) in order to be able to use an application AP (associated with a user interface IG), which here is hosted by a network device S. such as, for example, an application server, accessible via the communication network R (potentially via the Internet). However, the invention is not limited to this type of electronic device. Rather, it pertains to any type of electronic user device that has a screen or monitor and is capable of using at least one application AP that it hosts or which it may access via a wired or wireless communication network. Consequently, it may, for example, be a desktop or portable computer, a fixed-line or mobile telephone, a personal digital assistant (or PDA), potentially a communicating one, a game console that may potentially be a communicating one, a home appliance that may potentially be a communicating one, a television set that may potentially be a communicating one, or a multimedia content receiver (such as an STB or “Set-Top Box”), for example.

As indicated in the introduction, the term “user interface” refers here to all software elements that constitute the graphical user interface (or GUI) that is displayed on the screen (or monitor) of a user device Ei, potentially a communicating one, and with which that user may interact via one or more peripherals, such as a keyboard, mouse, touchscreen, or dictated words, to perform actions needed to carry out an application's tasks, and/or all hardware and software elements that constitute an audio interface enabling a user to provide (or dictate) keywords intended to trigger actions needed to carry out an application's tasks.

The sole FIGURE schematically depicts an example (communication) network R, potentially one connected to the network of networks (or Internet), and to which are connected, firstly, (communication) devices Ei belonging to subscribing users who are clients (whether directly or indirectly (roaming)) of the operator of said network R. and secondly, an application server S hosting an application AP associated with a user interface (or graphical user interface) IG and which may be used by the devices Ei via said user interface IG.

In the nonlimiting example depicted, three devices E1-E3 (i=1 to 3) are connected to the network R. However, the invention applies provided that at least one communication device Ei is connected to the network R.

It should be noted that the application AP may potentially form part of the network R, and particularly its network core, or part of a device Ei.

The invention proposes using at least one analysis apparatus D in order to automatically analyze, for example for an application provider or publisher, the usage by at least one user (of a device Ei) of at least one user interface IG associated with an application AP.

In what follows, it is assumed by way of a nonlimiting example that the analysis apparatus D is intended to analyze the use by multiple users of a single user interface IG associated with an application AP. However, such an (analysis) apparatus D may analyze the usage by multiple users of multiple user interfaces IG associated with different applications AP. Likewise, such an (analysis) apparatus D may be associated with a single device Ei in order to analyze the usage by its user of one or more user interfaces IG associated with one or more applications AP.

In the non-limiting example depicted, the apparatus D operates in a centralized fashion, and is installed in a network device ER, such as, for example, a server, which may access the application server S via the network R (and potentially the Internet). However, the apparatus D may also be installed within, or connected to, the application server S that hosts the application AP whose associated user interface's IG usage it is to analyze. Furthermore, in distributed operation, meaning for a single device Ei hosting an application AI and the associated user interface IG, the apparatus D may be either installed within that device EI or connected to it (Ei).

Consequently, an (analysis) apparatus D according to the invention may be constructed in the form of software (or information processing) modules, collectively constituting an information processing program (or computer program), or in the form of electronic circuits, or a combination of electronic circuits and software modules.

An (analysis) apparatus D according to the invention comprises at least one analysis module MA. That module (MA) is chiefly operative (or designed) to compare first data, which is representative of first actions performed by a user of an application AP, by means of the associated user interface IG, to carry out tasks that are required by that application AP, with second data, which is representative of second actions that that user should have performed by means of that user interface IG in order to carry out those required tasks, and third data, which is representative of the way in which that user should have performed those second actions.

In other words, the analysis module MA is tasked with comparing the results of the use of the user interface IG by one or more users (here represented by first data) with expected results (and therefore predefined by second and third data). To do so, the analysis module MA may, for example, be arranged in the form of a rule engine.

The comparisons made by the analysis module MA are intended to determine any differences (or variations) representative of shortcomings of the user interface IG in question.

The first data may be representative of events that are generated (or triggered) by the user interface IG whenever a user performs first actions with that user interface IG. These events may be, for example, a mouse movement, a mouse position, a selection click performed with a mouse or an input of an alphanumeric character within a text field of the user interface IG.

In one variant or as a complement, the events may also be generated by the application AP, which is associated with the user interface IG that is being used by a user, whenever that user performs first actions with that user interface IG. These events may be, for example, activating a function, a usage error detection (such as an incorrect input into text field), or an operating error (or “bug”) independent of the user.

The analysis module MA may either automatically receive the events from the application AP, here via the application server S and its network device ER, or monitor the application AP and pick up the events that it generates and/or that are generated by the associated user interface IG.

In order to make its comparisons, the analysis module MA may, for example, use second data that is representative of functional definitions (or specifications) of second actions that make it possible to perform tasks of the application in question AP. In other words, the second data define all of the (second) actions that should theoretically enable the users to perform that task of the application AP.

By way of nonlimiting examples, a second action may consist of entering a name within a dedicated field or of selecting a specific section of a (sub-)menu, or of performing a combination of elementary actions, such as, for example, filling out a field and then clicking “OK.”

It should be noted that this second data is stored in first storage means MS1 which, as depicted in a nonlimiting fashion, may form part of the apparatus D, although this is not mandatory.

These first storage means MS1 may come in any form known to the person skilled in the art, such as for example a memory (potentially a purely software memory) or a database.

Furthermore, in order to make its comparisons, the analysis module MA may, for example, use third data that is representative of models defining how to use second actions for successfully performing the various tasks of the application AP. In other words, the third data defined all rules or ergonomic and/or behavioral heuristics, whether qualitative or quantitative, that should theoretically enable the users to perform that second action.

By way of nonlimiting examples, a heuristic may specify that a user must not take longer than a chosen duration to perform a second action (such as, for example, clicking on a displayed icon) or a complete task, or that a user must not click more than three times to perform a second action.

It should be noted that this third data is stored in second storage means MS2 which, as depicted in a nonlimiting fashion, may form part of the apparatus D, although this is not mandatory.

These second storage means MS2 may come in any form known to the person skilled in the art, such as for example a memory (potentially a purely software memory) or a database.

It should also be noted that the first MS1 and second storage means MS2 may potentially form part of the same software module.

It should also be noted that the analysis module MA may be operative to measure the time taken by a user to perform a second action or task that requires at least one second action, and to use that measured time as first data during its comparisons. These time measurements may, for example, be performed by means of clocks or timers.

It should also be noted that the analysis module MA may be operative to “track” the movement of the mouse, in order to deduce, for example, a user's hesitation between multiple buttons or sections or (sub-)menus on which to click (or to be selected).

It should also be noted that the analysis apparatus D may also be designed so as to propose changes to the user interface IG that are covered by an analysis of use by its analysis module MA. In this situation, the apparatus D comprises an optimization module MO which is tasked with intervening every time that the analysis module MA has determined at least one difference, preferably one related to carrying out a complete task by at least one user. Each intervention may, for example, be required by the analysis module MA.

Each intervention is intended to determine whether the user interface IG in question may be modified to prevent each difference reported by the analysis module MA from reappearing again. If the optimization module MO estimates that it is not possible to reconcile a difference or a set of differences, it generates a message that it reports, and waits to be called upon again. On the other hand, if the optimization module MO estimates that it is possible to reconcile a difference or a set of differences, it determines at least one modification of the user interface IG in question that would enable the user or users of the application AP in question to more easily perform the tasks required by that application AP.

To do so, the optimization module MO may, for example, be arranged in the form of a rule engine.

It should be noted that the optimization module MO may, for example, be arranged to modify the user interface IG in question as a function of variants in the presentation of tasks to be performed, which constitute alternatives to task presentations used up to that point within that user interface IG. Replacing one presentation with another may actually prove beneficial to users, as it is very common for user interfaces' usage errors or users' hesitations during user interfaces' usage phases to result from insufficient prominence given to the displayed element that must be selected or within which an input must be performed.

By way of non-limiting examples, a presentation variant may be a rule specifying that if a difference consists of a user taking too long to select a section (or to enter input into a dedicated field), this results from the fact that the section (or the dedicated field) is not visible enough, and therefore its visibility must be strengthened (for example by an enlargement and/or a particular prominence (blinking, color(s), and likewise), or by a rule specifying that if a difference consists of quasi-systematic errors in selection or input by multiple users, then this results from an incomplete explanation, and therefore the text explaining the task to be performed must be modified (for example, completed), or a rule specifying that if a confusion between two neighboring buttons or sections or (sub-)menus has led to an error or hesitation, then the distance that separates them must be increased (this may, for example, be the case with a softphone device for which the buttons associated with the “pick up” and “hang up” functions are so close that this may lead to ignoring a call rather than accepting it).

These presentation variants are stored in third storage means MS3 which, as depicted in a nonlimiting fashion, may form part of the apparatus D, although this is not mandatory.

These third storage means MS3 may come in any form known to the person skilled in the art, such as for example a memory (potentially a purely software memory) or a database.

Once the optimization module MO has determined at least one modification that must be made to a user interface IG, it delivers to an output data that defines each determined modification. This modification data is, for example, lines of software code that are intended to be transmitted to the application AP in question (here, via the application server S that hosts it) in order for it to adapt its user interface IG accordingly. This transmission may be done automatically, or after obtaining an authorization from a qualified person.

The apparatus D may also comprise a generation module MG operative to store each modification that was determined by the optimization module MO, and to generate a report whenever the analysis module MA can no longer determine any significant difference subsequent to the modifications (potentially successive ones) made to the user interface IG in question.

It should be understood that once a modification is in effect within a user interface IG, the analysis module MA may verify, by a new analysis, if that modification made it possible to improve the use of that user interface IG by the users. It should be noted that despite the inclusion of a modification for a given task, a difference may remain for that same task. If this difference proves significant (meaning important with respect to the rules or heuristics used to determine it), then the optimization module MO is notified of this by the analysis module MA. Otherwise, the analysis module MA does not notify the optimization module MO.

The report that is generated is intended for a qualified person, who is in charge of managing the user interface IG in question. It may, for example, comprise the list of all modifications that have been successively made to a user interface IG, and which made it possible to achieve a true optimization of its use by one or more of the users in question.

It is important to note that the invention may also be considered from the perspective of an automated analysis method, which may particularly be implemented by means of an analysis apparatus D of the type presented above. As the functionalities provided by the implementation of the method according to the invention are identical to those provided by the apparatus D introduced above, only the combination of the main functionalities provided by the method is presented hereafter.

This analysis method comprises at least one step that is implemented every time a user uses an application AP, associated with a user interface IG, with a device (potentially a communication device) Ei.

This step consists of comparing first data that is representative of first actions performed by the user by means of the user interface IG that is associated with the application AP in order to carry out tasks required by that application AP, with second data that is representative of second actions that that user should have performed by means of that user interface IG in order to carry out those required tasks, and third data, representative of the way in which that user should have performed those second actions, in order to determine any differences representative of shortcomings of that user interface IG.

It should be noted that this method may also comprise an additional step consisting, in the event that at least one difference is determined, of determining whether the user interface IG can be modified to prevent each difference from reappearing again, and if so, of determining at least one modification of that user interface IG, intended to enable the user in question to more easily perform the tasks required by the application AP.

1. An apparatus for analyzing the use by at least one user of at least one user interface (IG) associated with an application (AP), wherein it comprises analysis means (MA) operative to compare first data, representative of first actions performed by said user by means of said user interface (IG) in order to carry out tasks required by said application (AP), with second data, representative of second actions that said user should have performed by means of said user interface (IG) in order to carry out said required tasks, and third data, representative of the way in which that user should have performed said second actions, in order to determine any differences representative of shortcomings of said user interface (IG).

2. An apparatus according to claim 1, wherein said analysis means (MA) are operative to use first data representative of events generated by said user interface (IG) and/or by said application (AP) whenever said user performs first actions with said user interface (IG).

3. An apparatus according to one claim 1, wherein said analysis means (MA) are operative to use second data representative of functional definitions of second actions that make it possible to perform tasks, and third data representative of usage models of said second actions for successfully performing said tasks.

4. An apparatus according to claim 1, wherein it comprises first storage means (MS1) operative to store said second data and/or second storage means (MS2) operative to store said third data.

5. An apparatus according to claim 1, wherein said analysis means (MA) are operative to measure the time taken by a user to perform a second action or a task requiring at least one second action, and to use said measured time as first data.

6. An apparatus according to claim 1, wherein it comprises optimization means (MO) operative, whenever said analysis means (MA) have determined at least one difference, to determine whether said user interface (IG) can be modified to keep each difference from reappearing again, and if so, to determine at least one modification of said user interface (IG) intended to enable said user to more easily perform said tasks required by said application (AP).

7. An apparatus according to claim 6, wherein said optimization means (MO) are operative to modify said user interface (IG) as a function of variants in the presentation of tasks to be performed, which constitute alternatives to task presentations used up to that point.

8. An apparatus according to claim 6, wherein it comprises generation means (MG) operative to store each modification determined by said optimization means (MO) and to generate a report whenever said analysis means (MA) do not determine any significant difference subsequent to the modifications made to said user interface (IG).

9. An apparatus according to claim 1, wherein said analysis means (MA) and/or said optimization means (MO) are configured in the form of a rule engine.

10. A computer program intended to be used by an electronic device (ER, Ei), wherein it constitutes an analysis apparatus (D) according to claim 1.

11. A network device (ER) for a communication network (R) offering access to at least one application (AP), wherein it comprises an analysis apparatus (D) according to claim 1.

12. A user device (Ei) comprising at least one application (AP), wherein it comprises an analysis apparatus (D) according to claim 1.

13. A method for analyzing the use by at least one user of at least one user interface (IG) associated with an application (AP), wherein it comprises a step of comparing first data representative of first actions performed by said user by means of said user interface (IG) in order to carry out tasks required by said application (AP), with second data, representative of second actions that said user should have performed by means of said user interface (IG) in order to carry out said required tasks, and third data, representative of the way in which that user should have performed said second actions, in order to determine any differences representative of shortcomings of said user interface (IG).

14. A method according to claim 13, wherein it further comprises a step consisting, in the event that at least one difference is determined, of determining whether said user interface (IG) can be modified to keep each difference from reappearing again, and if so, to determine at least one modification of said user interface (IG) intended to enable said user to more easily perform said tasks required by said application (AP).
